(19) United States
(12) Patent Application Publication
(10) Pub. No.: US 2005/0024196 A1
(43) Pub. Date: Feb. 3, 2005

(54) Turn signal indicating the vehicle is turning

(76) Inventor: Steven Clay Moore, Austin, TX (US)

Correspondence Address: STEVEN CLAY MOORE, 8211 LONG CANYON DRIVE, UNIT B, AUSTIN, TX, 78732, US

(21) Appl. No.: 10/607,291

(22) Filed: Jun. 27, 2003

(51) Int. Cl. B60Q 1/34

(52) U.S. Cl. 340/475

(57) ABSTRACT

This invention is to communicate to other drivers, by altering the frequency or intensity with which the turn signal blinks, that the vehicle is turning. This can be accomplished using either digital or analog control circuits, microcontrollers or pulse generators. Whether analog or digital, they communicate the difference between a driver intending to turn and the vehicle turning.

### REFERENCES CITED

| | | |
|---|---|---|
| 4,348,655 | Sep. 1982 | Goertler et al. |
| 5,281,950 | Jan., 1994 | Le |
| 5,614,884 | Jun., 1995 | Evans |
| 5,776,049 | Jul., 1998 | Schreiner |
| 5,790,017 | Aug., 1998 | Berryhill |
| 5,900,813 | May, 1999 | Ruminski et al. |
| 6,020,813 | Feb., 2000 | Harris et al. |
| 6,050,706 | Apr., 2000 | Ontuka |
| 6,144,297 | Nov., 2000 | Donner |
| 6,154,127 | Nov., 2000 | Lee et al. |
| 6,296,379 | Oct., 2001 | Pastrick |
| 6,426,695 | Jul., 2002 | Pagan et al. |

### CROSS-REFERENCE TO RELATED APPLICATIONS

Not Applicable

### STATEMENT REGARDING FEDERALLY SPONSORED RESEARCH

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The invention relates to communicating, by altering the turn signal, the difference between the driver intending to turn and the vehicle turning.

### BACKGROUND OF THE INVENTION

The brake, hazard and turn signal lights on a vehicle communicate what the driver either intends to do or is doing. Beyond implying basic directions and vague intents, the lighting systems on automobiles, motorcycles and other vehicles do little else to stop miscommunication and prevent accidents.

The technology behind turn signals has remained stagnant for decades, as vehicles still use a thermal flasher, relying on the thermodynamic properties of steel or other metals. These systems are inexpensive and reliable, but are inflexible, unable to detect the difference between the driver intending to turn and when the vehicle is turning.

U.S. Pat. No. 4,348,655, by Goertler, is a turn signal system consisting of pulse generators that alter the frequency of the turn signal. Goertler's invention differs from this one by selecting which pulse generator powers the turn signal lamps by sensing the speed of the vehicle and whether the lights are on. There is no mention of changing the frequency or intensity with which the turn signals blink when the vehicle is turning and the Goertler's invention does not sense shaft position, wheel position, or other parts of the vehicle associated with turning.

Other inventions in the art relate to sending a predetermined number of pulses to the turn signal lamps, systems that sense when the turn signal is active and the car is not turning, adding turn signal lamps on mirrors, augmenting the turn signal system on wide turning vehicles with strobe lights, and enhancing lamp appearance. None of these, or any other inventions in the art found from patent text and title searches, are the same as the present invention.

### BRIEF SUMMARY OF THE INVENTION

This invention is to detect when the vehicle is turning and alter the frequency or intensity of the turn signal to communicate that the vehicle is turning. Sensing that the turn signal is activated and the vehicle is turning can be accomplished a variety of ways, as can processing the sensory data and outputting the altered turn signal.

### BRIEF DESCRIPTION OF THE DRAWINGS

Not Applicable

### DETAILED DESCRIPTION OF THE INVENTION

The present uivention can be partitioned into two sections: detecting if the turn signal is active and if the vehicle is turning and driving the turn signal lamps with the altered signal. Detecting if the turn signal is active is simple; as the driver activates the turn signal there is a change in continuity. Detecting if the vehicle is turning is more difficult and can be accomplished in different ways. The simplest way is to use a shaft sensor, which is commercially available, to detect the position of the shaft. Other ways to detect if the vehicle is turning include, and are not limited to, resistive, capacitive and inductive sensors that detect angular displacement and thus can detect the angle of the wheels or the rotational displacement of the shaft.

The bridge between the sensory and switch inputs to outputting the altered turn signal is the control circuit. The control can be analog, using the analog voltages from switches and sensors to control pulse generators or other integrated circuits where the duty cycle and amplitude of the output signal is dependent upon analog voltage levels.

It is more reliable and economically feasible to use a microcontroller and other digital hardware to control the system. This requires digitizing the analog signals from the sensors and switches. Switches are inherently digital in nature; all that is required to digitize the signal from the lever is connecting the desired voltage level for a logic value of 1 across the switch in series with a resistor valued between 1,000 and 10,000 ohms. The sensor detecting if the vehicle is turning also needs to be digitized by means of an analog to digital converter.

Whether the control is analog or digital, the system needs to output the altered turn signal to the turn signal lamps. If the system is analog, the circuitry associated with driving the turn signal lamps needs to have low source impedance and the current capabilities to drive the turn signal lamps with the desired frequency and amplitude. If the system is digital, the microcontroller output needs to be converted to an analog signal through a digital to analog converter, and go through an amplifier with a low source impedance and the capability to power the turn signal lamps at the altered frequency and intensity.

Finally, whether the system is analog or digital, the primary function of the system is to communicate to other drivers that the vehicle is turning. By varying the frequency or intensity with which the turn signal blinks, the system communicates to other drivers that the vehicle is turning. Similarly, the system can communicate to other motorists by varying the frequency or intensity of the turn signal in proportion to the position of the shaft, angle of the wheels, or the amount of time the car has been turning.

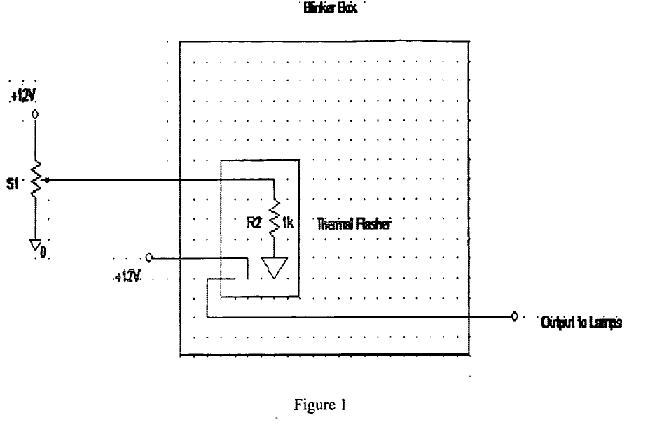

FIG. 1 is the preferred embodiment of the invention; an analog design using a shaft position sensor (S1) to drive the thermal flasher where the voltage output from the sensor determines the amount of current through the thermal flasher and thus the speed at which the turn signal lights blink. This setup uses the position of the shaft to change the frequency with which the turn signals flash.

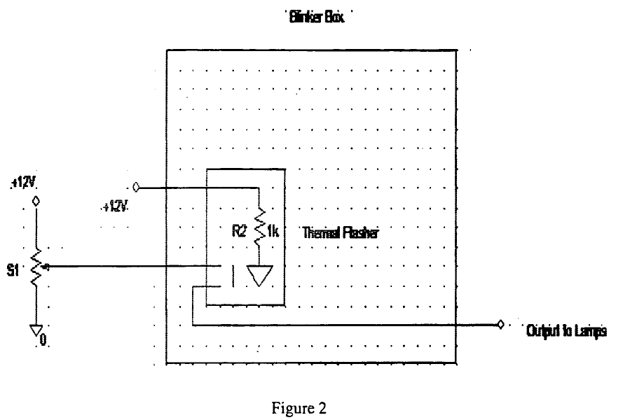

FIG. 2 is an embodiment similar to FIG. 1; the difference being that the system in FIG. 2 uses the shaft position sensor (S1) to alter the intensity of the turn signal as the vehicle turns.

1. A system that senses when the turn signal is active and the vehicle is turning and indicates that the vehicle is turning by varying the frequency and/or intensity with which the turn signal blinks, signaling to other motorists that the vehicle is turning.

2. A system as described in claim 1 further comprising using a microcontroller, or microcontrollers, to take the switching and sensory inputs and output the pulsing sequence to a circuit that drives the turn signal lamps when the vehicle is turning.

3. A system as described in claim 1 further comprising using pulse generators, or other circuits where the duty cycle and amplitude of the output signal is dependent upon analog voltage levels, to output the pulsing sequence to a circuit that drives the turn signal lamps when the vehicle is turning.

4. A system as described in claim 1 further comprising using a shaft position sensor, or other resistive, capacitive or inductive sensor, to determine the amount to alter the frequency or intensity of the turn signal.

5. A system as described in claim 1 further comprising adjusting the turn signal frequency and/or intensity proportionally to the position of the shaft and/or the amount of time the vehicle has been turning.
